(19) United States
(12) Patent Application Publication
(10) Pub. No.: US 2011/0007905 A1
(43) Pub. Date: Jan. 13, 2011

(54) ACOUSTIC SIGNAL PROCESSING DEVICE AND ACOUSTIC SIGNAL PROCESSING METHOD

(75) Inventors: Shinichi Sato, Higashiyamato (JP); Nobuhiro Tomoda, Tsaragashima (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/866,348

(22) PCT Filed: Feb. 26, 2008
(86) PCT No.: PCT/JP2008/053298

§ 371 Date: Aug. 5, 2010

(51) Int. Cl. H04R 29/00

(52) U.S. Cl. 381/59

(57) ABSTRACT

In a processing control unit 119, a correction measurement unit measures an aspect of sound field correction processing executed upon an acoustic signal UAS received from a sound source device 920₀, that is a particular external device. And if an acoustic signal NAS or an acoustic signal NAD other than the acoustic signal UAS is selected as an acoustic signal to be supplied to speaker units 910_{L}, through 910_{SR}, then a sound field correction unit 113 generates an acoustic signal APD by executing sound field correction processing for the aforementioned measured aspect upon the selected acoustic signal. Due to this, whichever of the plurality of acoustic signals UAS, NAS, and NAD is selected, it is possible to supply that signal to the speaker units 910_{L}, through 910_{SR} in a state in which uniform sound field correction processing has been executed thereupon.

### TECHNICAL FIELD

The present invention relates to an acoustic signal processing device, to an acoustic signal processing method, to an acoustic signal processing program, and to a recording medium upon which that acoustic signal processing program is recorded.

### BACKGROUND ART

In recent years, along with the widespread use of DVDs (Digital Versatile Disks) and so on, audio devices of the multi-channel surround sound type having a plurality of speakers have also become widespread. Due to this, it has become possible to enjoy surround sound brimming over with realism both in interior household spaces and in vehicle interior spaces.

There are various types of installation environment for audio devices of this type. Because of this, quite often circumstances occur in which it is not possible to arrange a plurality of speakers that output audio in positions which are symmetrical from the standpoint of the multi-channel surround sound format. In particular, if an audio device that employs the multi-channel surround sound format is to be installed in a vehicle, due to constraints upon the sitting position which is also the listening position, it is not possible to arrange a plurality of speakers in the symmetrical positions which are recommended from the standpoint of the multi-channel surround sound format. Furthermore, when the multi-channel surround sound format is implemented, it is often the case that the characteristics of the speakers are not optimal. Due to this, in order to obtain good quality surround sound by employing the multi-channel surround sound format, it becomes necessary to correct the sound field by correcting the acoustic signals.

Now, the audio devices (hereinafter termed “sound source devices”) for which acoustic signal correction of the kind described above for sound field correction and so on becomes necessary are not limited to being devices of a single type. For example, as sound source devices that are expected to be mounted in vehicles, there are players that replay the contents of audio of the type described above recorded upon a DVD or the like, broadcast reception devices that replay the contents of audio received upon broadcast waves, and so on. In these circumstances, a technique has been proposed for standardization of means for acoustic signal correction (refer to Patent Document #1, which is hereinafter referred to as the “prior art example”).

With the technique of this prior art example, along with acoustic signals being inputted from a plurality of sound source devices, audio that corresponds to that sound source device for which replay selection has been performed is replay outputted from the speakers. And, when the selection for replay is changed over, audio volume correction is performed by an audio volume correction means that is common to the plurality of sound source devices, in order to make the audio volume level appropriate.

Patent Document #1: Japanese Laid-Open Patent Publication 2006-99834.

### DISCLOSURE OF THE INVENTION

### Problems to be Solved by the Invention

The technique of the prior art example described above is a technique for suppressing the occurrence of a sense of discomfort in the user with respect to audio volume, due to changeover of the sound source device. Due to this, the technique of the prior art example is not one in which sound field correction processing is performed for making it appear that the sound field created by output audio from a plurality of speakers is brimming over with realism.

Now, for example, sound field correction processing that is specified for the original acoustic signal and that is faithful to its acoustic contents may be executed within a sound source device which is mounted to a vehicle during manufacture of the vehicle (i.e. which is so called original equipment), so as to generate acoustic signals for supply to the speakers. On the other hand, in the case of an audio device that is not original equipment, generally the original acoustic signal is generated as the acoustic signal to be supplied to the speakers. Due to this, when audio replay is performed with a sound source device in which sound field correction processing is executed and a sound source device in which no sound field correction processing is executed being changed over, the occurrence of a difference in sound texture becomes apparent to the user.

Because of this fact, a technique is desirable by which it would be possible to perform audio replay with no sense of discomfort from the point of view of the user, even if audio replay is performed with a sound source device in which sound field correction processing is executed and a sound source device in which no sound field correction processing is executed being changed over. To respond to this requirement is considered as being one of the problems that the present invention should solve.

The present invention has been conceived in the light of the circumstances described above, and its object is to provide an acoustic signal processing device and an acoustic signal processing method, that are capable of supplying output acoustic signals to speakers in a state in which uniform sound field correction processing has been executed thereupon, whichever one of a plurality of acoustic signals is selected.

### Means for Solving the Problems

Considered from the first standpoint, the present invention is an acoustic signal processing device that creates acoustic signals that are supplied to a plurality of speakers, characterized by comprising: a reception means that receives an acoustic signal from each of a plurality of external devices; a measurement means that measures an aspect of sound field correction processing executed upon an acoustic signal received from a specified one of said plurality of external devices; and a generation means that, when an acoustic signal received from an external device other than said specified external device has been selected, as acoustic signals to be supplied to said plurality of speakers, generates acoustic signals by executing sound field correction processing upon said selected acoustic signal for the aspect measured by said measurement means.

And, considered from a second standpoint, the present invention is an acoustic signal processing method that creates acoustic signals that are supplied to a plurality of speakers, characterized by including: a measurement process of measuring an aspect of sound field correction processing executed upon an acoustic signal received from a specified one of a plurality of external devices; and a generation process of, when an acoustic signal received from an external device other than said specified external device has been selected, as acoustic signals to be supplied to said plurality of speakers, generating acoustic signals by executing sound field correction processing upon said selected acoustic signal for the aspect measured by said measurement process.

Moreover, considered from a third standpoint, the present invention is an acoustic signal processing program, characterized in that it causes a calculation means to execute an acoustic signal processing method according to the present invention.

And, considered from a fourth standpoint, the present invention is a recording medium, characterized in that an acoustic signal processing program according to the present invention is recorded thereupon in a manner that is readable by a calculation means.

### BRIEF DESCRIPTION OF THE DRAWINGS

FIG. 1 is a block diagram schematically showing the structure of an acoustic signal processing device according to an embodiment of the present invention;

FIG. 2 is a figure for explanation of the positions in which four speaker units of FIG. 1 are arranged;

FIG. 3 is a block diagram for explanation of the structure of a control unit of FIG. 1;

FIG. 4 is a block diagram for explanation of the structure of a reception processing unit of FIG. 3;

FIG. 5 is a block diagram for explanation of the structure of a sound field correction unit of FIG. 3;

FIG. 6 is a block diagram for explanation of the structure of a processing control unit of FIG. 3;

FIG. 7 is a figure for explanation of audio contents for measurement, used during measurement for synchronization correction processing;

FIG. 8 is a figure for explanation of a signal which is the subject of measurement during measurement for synchronization correction processing; and

FIG. 9 is a flow chart for explanation of measurement of aspects of sound field correction processing for a sound source device 920₀, and for explanation of establishing sound field correction processing settings in the device of FIG. 1.

### BEST MODES FOR CARRYING OUT THE INVENTION

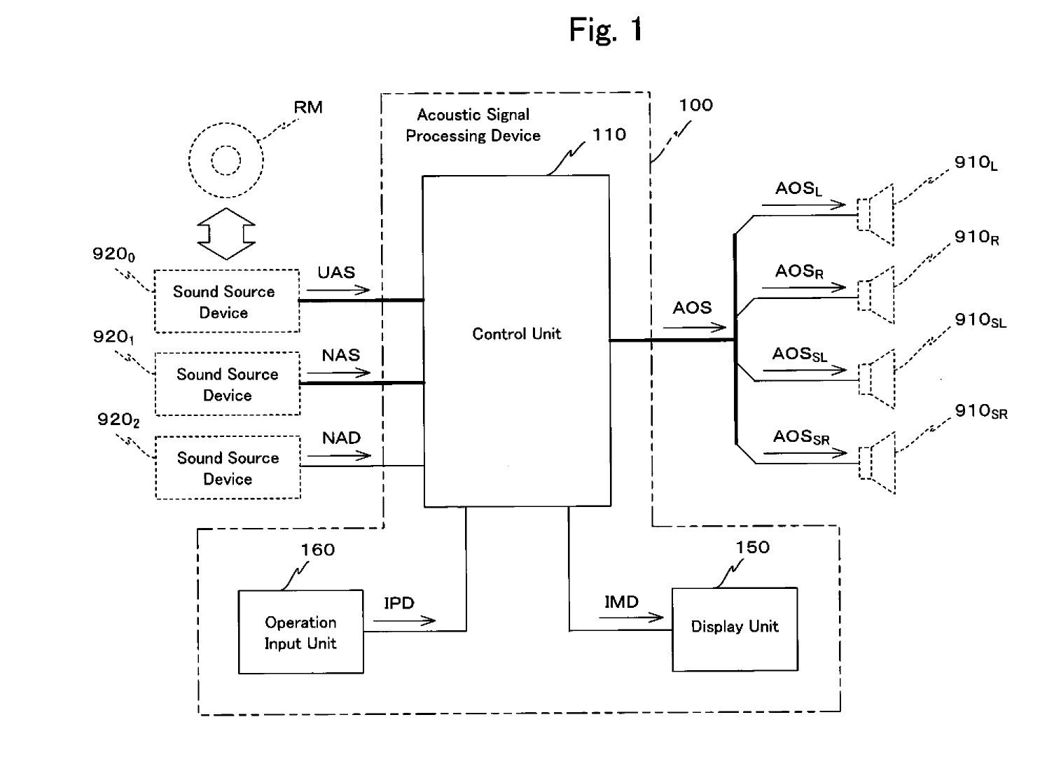

In the following, embodiments of the present invention will be explained with reference to FIGS. 1 through 9. It should be understood that, in the following explanation and the drawings, to elements which are the same or equivalent, the same reference symbols are appended, and duplicated explanation is omitted.

### Constitution

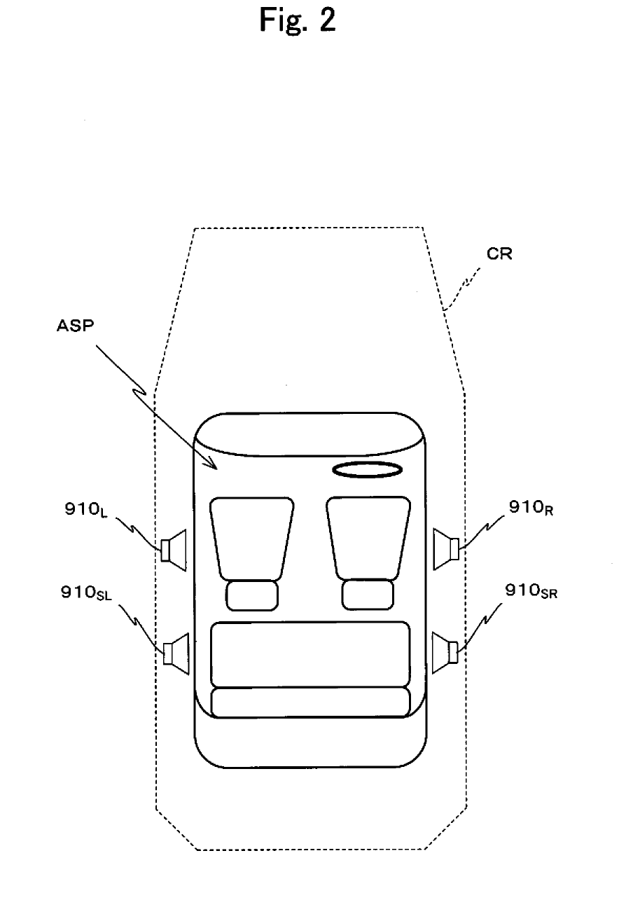

In FIG. 1, the schematic structure of an acoustic signal processing device 100 according to an embodiment is shown as a block diagram. It should be understood that, in the following explanation, it will be supposed that this acoustic signal processing device 100 is a device that is mounted to a vehicle CR (refer to FIG. 2). Moreover, it will be supposed that this acoustic signal processing device 100 performs processing upon an acoustic signal of the four channel surround sound format, which is one multi-channel surround sound format. It will be supposed that by an acoustic signal of the four channel surround sound format, is meant an acoustic signal having a four channel structure and including a left channel (hereinafter termed the “L channel”), a right channel (hereinafter termed the “R channel”), a surround left channel (hereinafter termed the “SL channel”), and a surround right channel (hereinafter termed the “SR channel”).

As shown in FIG. 1, speaker units 910_{L} through 910_{SR} that correspond to the L to SR channels are connected to this acoustic signal processing device 100. Each of these speaker units 910ⱼ (where j=L to SR) replays and outputs sound according to an individual output acoustic signal AOSⱼ in an output acoustic signal AOS that is dispatched from a control unit 110.

In this embodiment, as shown in FIG. 2, the speaker unit 910_{L} is disposed within the frame of the front door on the passenger's seat side. This speaker unit 910_{L}, is arranged so as to face the passenger's seat.

Moreover, the speaker unit 910_{R} is disposed within the frame of the front door on the driver's seat side. This speaker unit 910_{R} is arranged so as to face the driver's seat.

Furthermore, the speaker unit 910_{SL} is disposed within the portion of the vehicle frame behind the passenger's seat on that side. This speaker unit 910_{SL} is arranged so as to face the portion of the rear seat on the passenger's seat side.

Yet further, the speaker unit 910_{SR} is disposed within the portion of the vehicle frame behind the driver's seat on that side. This speaker unit 910_{SR} is arranged so as to face the portion of the rear seat on the driver's seat side.

With the arrangement as described above, audio is outputted into the sound field space ASP from the speaker units 910_{L} through 910_{SR}.

Returning to FIG. 1, sound source devices 920₀, 920₁, and 920₂ are connected to the acoustic signal processing device 100. Here, it is arranged for each of the sound source devices 920₀, 920₁, and 920₂ to generate an acoustic signal on the basis of audio contents, and to send that signal to the acoustic signal processing device 100.

The sound source device 920₀ described above generates an original acoustic signal of a four channel structure that is faithful to the audio contents recorded upon a recording medium RM such as a DVD (Digital Versatile Disk) or the like. Sound field correction processing is executed upon that original acoustic signal by the sound source device 920₀, and an acoustic signal UAS is thereby generated. In this embodiment, it will be supposed that this sound field correction processing that is executed upon the original acoustic signal by the sound source device 920₀ is sound field correction processing corresponding to this case in which replay audio is outputted from the speaker units 910_{L} through 910_{SR} to the sound field space ASP.

It should be understood that, in this embodiment, this acoustic signal UAS consists of four analog signals UAS_{L} through UAS_{SR}. Here, each of the analog signals UASⱼ (where j=L to SR) is a signal in a format that can be supplied to the corresponding speaker unit 910ⱼ.

The sound source device 920₁ described above generates an original acoustic signal of a four channel structure that is faithful to audio contents. This original acoustic signal from the sound source device 920₁ is then sent to the acoustic signal processing device 100 as an acoustic signal NAS. It should be understood that, in this embodiment, this acoustic signal NAS consists of four analog signals NAS_{L} through NAS_{SR}. Here, the analog signal NASⱼ (where j=L to SR) is a signal in a format that can be supplied to the corresponding speaker unit 910j.

The sound source device 920₂ described above generates an original acoustic signal of a four channel structure that is faithful to audio contents. This original acoustic signal from the sound source device 920₂ is then sent to the acoustic signal processing device 100 as an acoustic signal NAD. It should be understood that, in this embodiment, the acoustic signal NAD is a digital signal in which signal separation for each of the four channels is not performed.

Next, the details of the above described acoustic signal processing device 100 according to this embodiment will be explained. As shown in FIG. 1, this acoustic signal processing device 100 comprises a control unit 110, a display unit 150, and an operation input unit 160.

The control unit 110 performs processing for generation of the output acoustic signal AOS, on the basis of measurement processing of aspects of the appropriate sound field correction processing described above, and on the basis of the acoustic signal from one or another of the sound source devices 920₀ through 920₂. This control unit 110 will be described hereinafter.

The display unit 150 described above may comprise, for example: (i) a display device such as, for example, a liquid crystal panel, an organic EL (Electro Luminescent) panel, a PDP (Plasma Display Panel), or the like; (ii) a display controller such as a graphic renderer or the like, that performs control of the entire display unit 150; (iii) a display image memory that stores display image data; and so on. This display unit 150 displays operation guidance information and so on, according to display data IMD from the control unit 110.

The operation input unit 160 described above is a key unit that is provided to the main portion of the acoustic signal processing device 100, and/or a remote input device that includes a key unit, or the like. Here, a touch panel provided to the display device of the display unit 150 may be used as the key unit that is provided to the main portion. It should be understood that it would also be possible to use, instead of a structure that includes a key unit, or in parallel therewith, a structure in which an audio recognition technique is employed and input is via voice.

Setting of the details of the operation of the acoustic signal processing device 100 is performed by the user operating this operation input unit 160. For example, the user may utilize the operation input unit 160 to issue: a command for measurement of aspects of the proper sound field correction processing; an audio selection command for selecting which of the sound source devices 920₀ through 920₂ should be taken as that sound source device from which audio based upon its acoustic signal should be outputted from the speaker units 910_{L} through 910_{SR}; and the like. The input details set in this manner are sent from the operation input unit 160 to the control unit 110 as operation input data IPD.

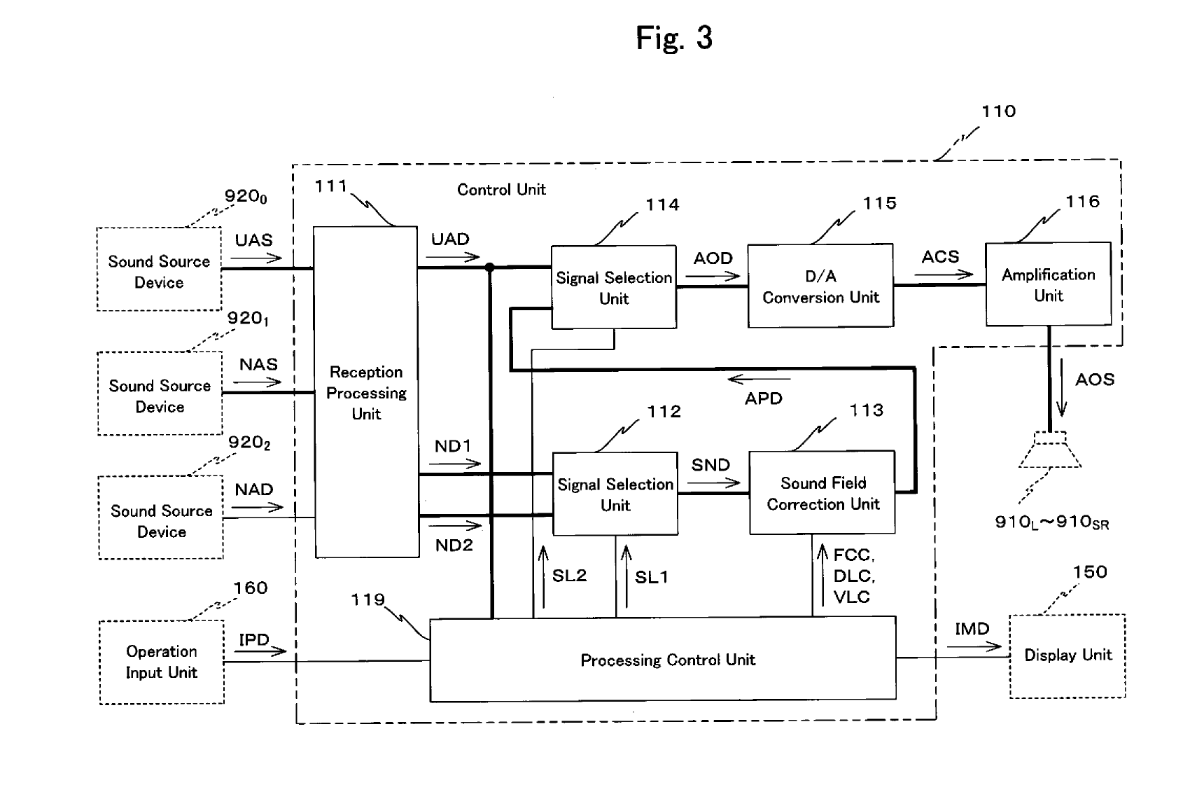

As shown in FIG. 3, the control unit 110 described above comprises a reception processing unit 111 that serves as a reception means, a signal selection unit 112, and a sound field correction unit 113 that serves as a generation means. Moreover, this control unit 110 further comprises another signal selection unit 114, a D/A (Digital to Analog) conversion unit 115, an amplification unit 116, and a processing control unit 119.

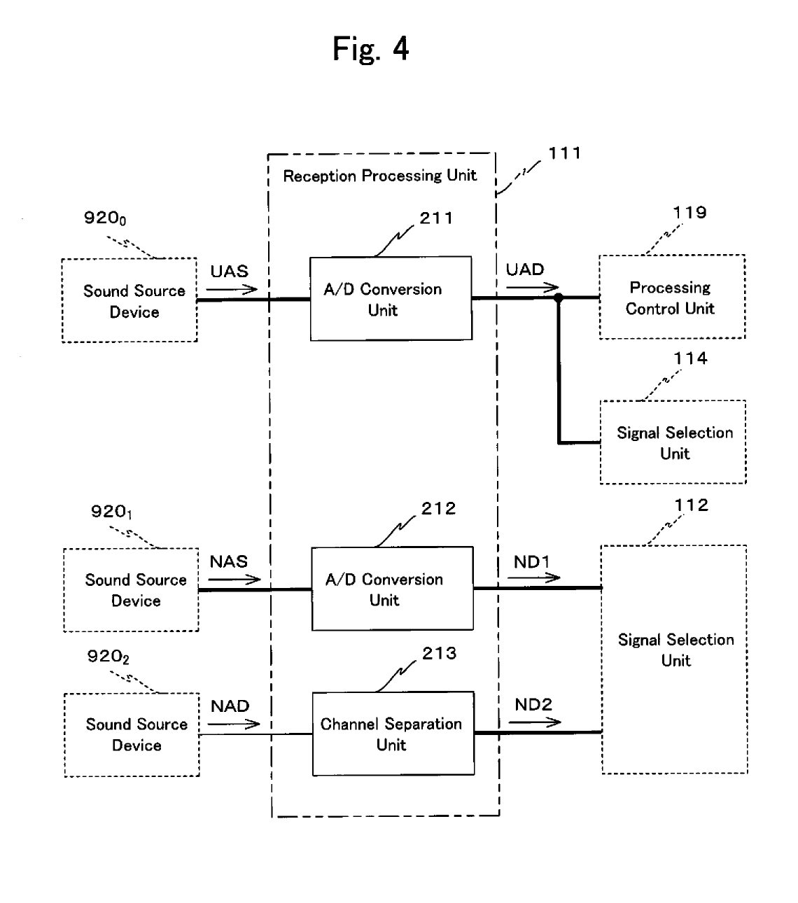

The reception processing unit 111 described above receives the acoustic signal UAS from the sound source device 920₀, the acoustic signal NAS from the sound source device 920₁, and the acoustic signal NAD from the sound source device 920₂. And the reception processing unit 111 generates a signal UAD from the acoustic signal UAS, generates a signal ND1 from the acoustic signal NAS, and generates a signal ND2 from the acoustic signal NAD. As shown in FIG. 4, this reception processing unit 111 comprises A/D (Analog to Digital) conversion units 211 and 212, and a channel separation unit 213.

The A/D conversion unit 211 described above includes four A/D converters. This A/D conversion unit 211 receives the acoustic signal UAS from the sound source device 920₀. And the A/D conversion unit 211 performs A/D conversion upon each of the individual acoustic signals UA_{SL} through UAS_{SR}, which are the analog signals included in the acoustic signal UAS, and generates a signal UAD in digital format. This signal UAD that has been generated in this manner is sent to the processing control unit 119 and to the signal selection unit 114. It should be understood that separate signals UADⱼ that result from A/D conversion of the separate acoustic signals UASⱼ are included in this signal UAD.

Like the A/D conversion unit 211, the A/D conversion unit 212 described above includes four separate A/D converters. This A/D conversion unit 212 receives the acoustic signal NAS from the sound source device 920₁. And the A/D conversion unit 212 performs A/D conversion upon each of the individual acoustic signals NAS_{L} through NAS_{SR}, which are the analog signals included in the acoustic signal NAS, and generates the signal ND1 which is in digital format. The signal ND1 that is generated in this manner is sent to the signal selection unit 112. It should be understood that individual signals ND1ⱼ resulting from A/D conversion of the individual acoustic signals NASⱼ (where j=L to SR) are included in the signal ND1.

The channel separation unit 213 described above receives the acoustic signal NAD from the sound source device 920₂. And this channel separation unit 213 analyzes the acoustic signal NAD, and generates the signal ND2 by separating the acoustic signal NAD into individual signals ND2_{L} through ND2_{SR} that correspond to the L through SR channels of the four-channel surround sound format, according to the channel designation information included in the acoustic signal NAD. The signal ND2 that is generated in this manner is sent to the signal selection unit 112.

Returning to FIG. 3, the signal selection unit 112 described above receives the signals ND1 and ND2 from the reception processing unit 111. And the signal selection unit 112 selects either one of the signals ND1 and ND2 according to the signal selection designation SL1 from the processing control unit 119, and sends it to the sound field correction unit 113 as the signal SND. Here, this signal SND includes individual signals SND_{L} through SND_{SR} corresponding to L through SR.

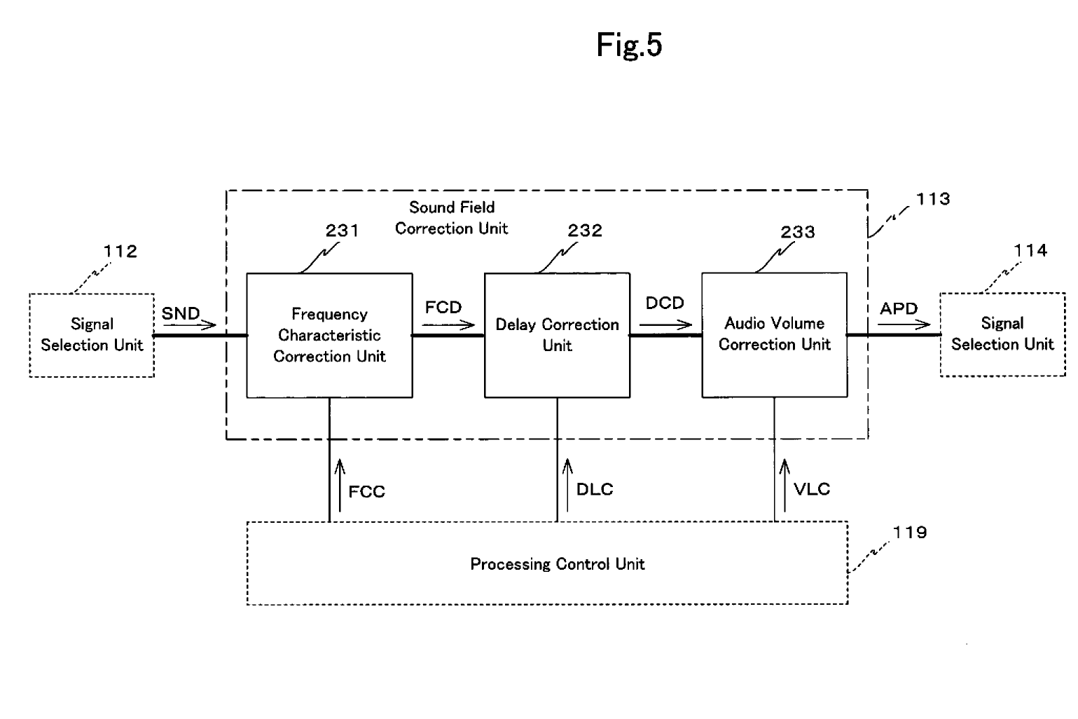

The sound field correction unit 113 described above receives the signal SND from the signal selection unit 112. And the sound field correction unit 113 performs sound field correction processing upon this signal SND, according to designation from the processing control unit 119. As shown in FIG. 5, this sound field correction unit 113 comprises a frequency characteristic correction unit 231, a delay correction unit 232, and an audio volume correction unit 233.

The frequency characteristic correction unit 231 described above receives the signal SND from the signal selection unit 112. And the frequency characteristic correction unit 231 generates a signal FCD that includes individual signals FCD_{L} through FCD_{SR} by correcting the frequency characteristic of each of the individual signals SND_{L} through SND_{SR} in the signal SND according to a frequency characteristic correction command FCC from the processing control unit 119. The signal FCD that has been generated in this manner is sent to the delay correction unit 232.

It should be understood that the frequency characteristic correction unit 231 comprises individual frequency characteristic correction means such as, for example, equalizer means or the like, provided for each of the signals SND_{L} through SND_{SR}. Furthermore, it is arranged for the frequency characteristic correction command FCC to include individual frequency characteristic correction commands FCC_{L} through FCC_{SR} corresponding to the individual signals SND_{L} through SND_{SR} respectively.

The delay correction unit 232 described above receives the signal FCD from the frequency characteristic correction unit 231. And the delay correction unit 232 generates a signal DCD that includes individual signals DCD_{L} through DCD_{SR}, in which the respective individual signals FCD_{L} through FCD_{SR} in the signal FCD have been delayed according to a delay control command DLC from the processing control unit 119. The signal DCD that has been generated in this manner is sent to the audio volume correction unit 233.

It should be understood that the delay correction unit 232 includes individual variable delay means that are provided for each of the individual signals FCD_{L} through FCD_{SR}. Furthermore, it is arranged for the delay control command DLC to include individual delay control commands DLC_{L} through DLC_{SR}, respectively corresponding to the individual signals FCD_{L} through FCD_{SR}.

The audio volume correction unit 233 described above receives the signal DCD from the delay correction unit 232. And the audio volume correction unit 233 generates a signal APD that includes individual signals APD_{L} through APD_{SR}, in which the audio volumes of the respective individual signals DCD_{L} through DCD_{SR} in the signal DCD have been corrected according to an audio volume correction command VLC from the processing control unit 119. The signal APD that has been generated in this manner is sent to the signal selection unit 114.

It should be understood that the audio volume correction unit 233 includes individual audio volume correction means, for example variable attenuation means or the like, provided for each of the individual signals DCD_{L} through DCD_{SR}. Moreover, it is arranged for the audio volume correction command VLC to include individual audio volume correction commands VLC_{L} through VLC_{SR} corresponding respectively to the individual signals DCD_{L} through DCD_{SR}.

Returning to FIG. 3, the signal selection unit 114 described above receives the signal UAD from the reception processing unit 111 and the signal APD from the sound field correction unit 113. And, according to the signal selection designation SL2 from the processing control unit 119, this signal selection unit 114 selects one or the other of the signal UAD and the signal APD and sends it to the D/A conversion unit 115 as a signal AOD. Here, individual signals AOD_{L} through AOD_{SR} corresponding to the channels L through SR are included in this signal AOD.

The D/A conversion unit 115 described above includes four D/A converters. This D/A conversion unit 115 receives the signal AOD from the signal selection unit 114. And the D/A conversion unit 115 performs A/D conversion upon each of the individual signals AOD_{L} through AOD_{SR} included in the signal AOD, thus generating a signal ACS in analog format. The signal ACS that has been generated in this manner is sent to the amplification unit 116. It should be understood that individual signals ACSⱼ resulting from D/A conversion of the individual signals AODⱼ (where j=L to SR) are included in the signal ACS.

It is arranged for the amplification unit 116 described above to include four power amplification means. This amplification unit 116 receives the signal ACS from the D/A conversion unit 115. And the amplification unit 116 performs power amplification upon each of the individual signals ACS_{L} through ACS_{SR} included in the signal ACS, and thereby generates the output acoustic signal AOS. The individual output acoustic signals AOSⱼ in the output acoustic signal AOS that has been generated in this manner are sent to the speaker units 910ⱼ.

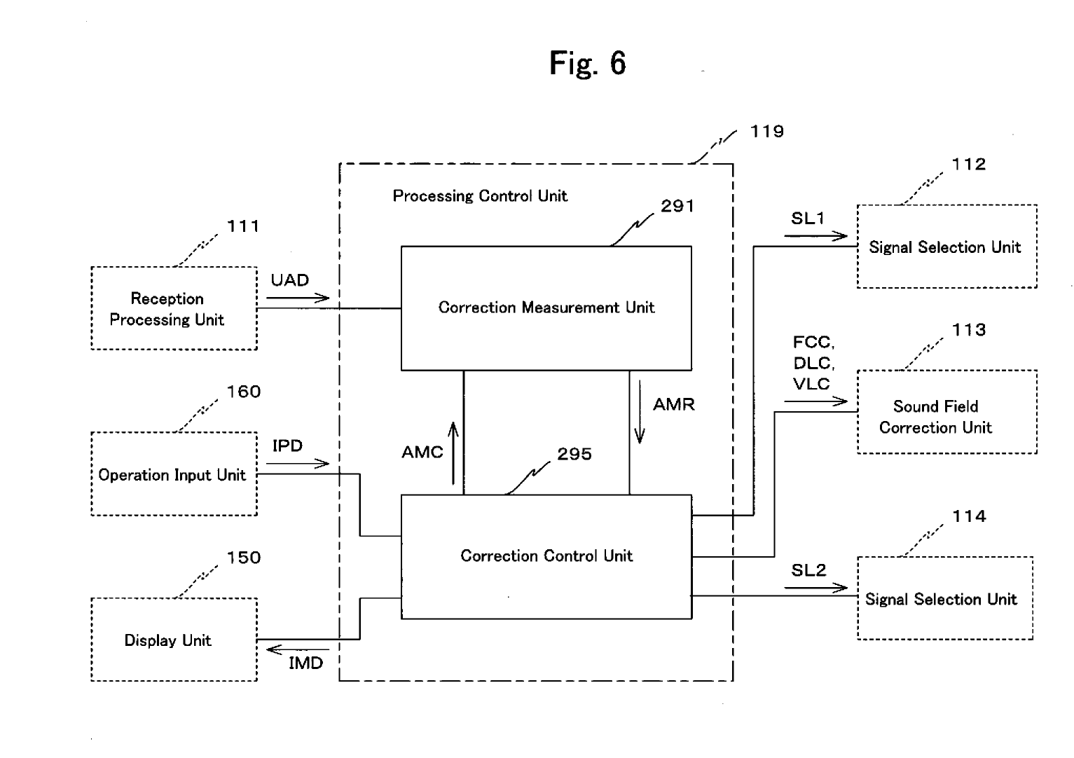

The processing control unit 119 described above performs various kinds of processing, and thereby controls the operation of the acoustic signal processing device 100. As shown in FIG. 6, this processing control unit 119 comprises a correction measurement unit 291 that serves as a measurement means, and a correction control unit 295.

Based upon control by the correction control unit 295, the correction measurement unit 291 described above analyzes the signal UAD resulting from A/D conversion of the acoustic signal UAS generated by the sound source device 920₀ on the basis of the audio contents for measurement recorded upon a recording medium for measurement in the reception processing unit 111, and measures certain aspects of the sound field correction processing by the sound source device 920₀. It is arranged for this correction measurement unit 291 to measure the aspect of the frequency characteristic correction processing included in the sound field correction processing that is performed in the sound source device 920₀, the aspect of the synchronization correction processing included therein, and the aspect of the audio volume balance correction processing included therein. A correction measurement result AMR that is the result of this measurement by the correction measurement unit 291 is reported to the correction control unit 295.

Here by “frequency characteristic correction processing” is referred to as correction processing for the frequency characteristic that is executed upon each of the individual acoustic signals corresponding to the channels L through SR in the original acoustic signal. Moreover, by “synchronization correction processing” is referred to as correction processing for the timing of audio output from each of the speaker units 901_{L} through 910_{SR}. Yet further, by “audio volume balance correction processing” is referred to as correction processing related to the volume of the sound outputted from each of the speaker units 901_{L} through 910_{SR}, for balance between the speaker units.

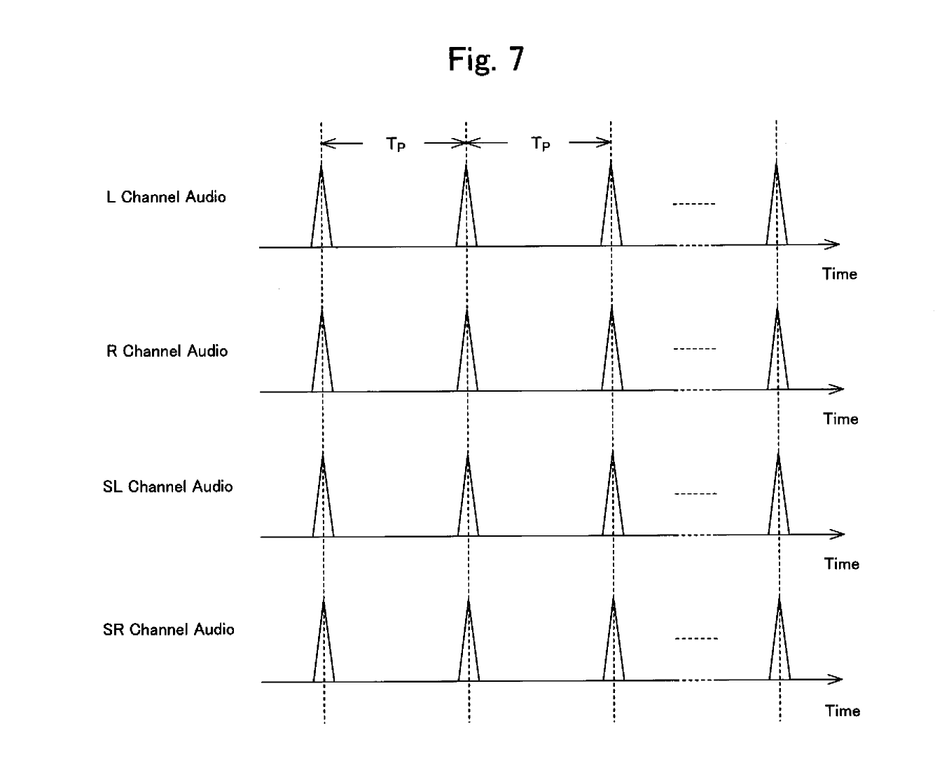

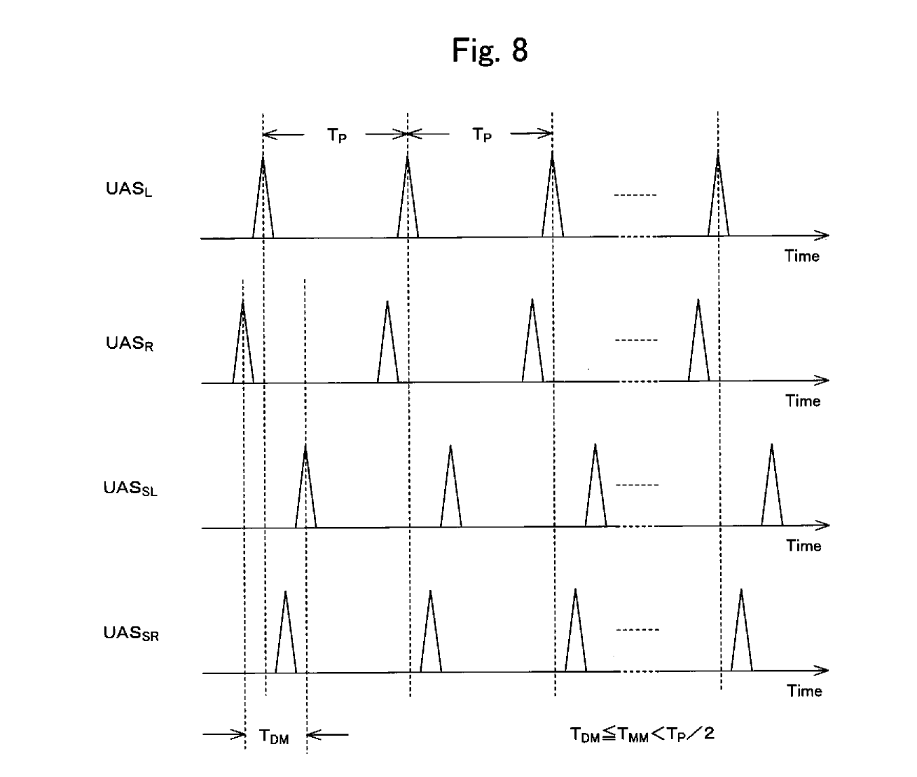

When measuring aspects of the synchronization correction processing, as shown in FIG. 7, pulse form sounds generated simultaneously at a period T_{P} and corresponding to the channels L through SR are used as the audio contents for measurement. When sound field correction processing corresponding to the audio contents for synchronization measurement is executed in this way by the sound source device 920₀ upon the original acoustic signal, the acoustic signal UAS in which the individual acoustic signals UAS_{L} through UAS_{SR} are included is supplied to the control unit 110 as the result of this synchronization correction processing in the sound field correction processing, as for example shown in FIG. 8.

Here, for the period T_{P}, a time period is taken that is longer than twice the supposed maximum time period difference T_{MM}, which is supposed to be the maximum delay time period difference T_{DM}, which is the maximum value of the delay time period difference imparted to the individual acoustic signals UAS_{L} through UAS_{SR} by the synchronization correction processing in the sound source device 920₀. Furthermore the correction measurement unit 291 measures aspects of the synchronization correction processing by the sound source device 920₀ by taking, as the subject of analysis, pulses in the individual acoustic signals UAS_{L} through UAS_{SR} after a time period of T_{P}/2 has elapsed after a pulse in any of the individual acoustic signals UAS_{L} through UAS_{SR} has been initially detected. By doing this, even if undesirably there is some deviation between the timing of generation of the acoustic signal UAS for measurement of the synchronization correction processing, and the timing at which the signal UAD is obtained by the correction measurement unit 291, still the correction measurement unit 291 is able to perform measurement of the aspects of the above synchronization correction processing correctly, since the pulses that are to be the subject of analysis are detected by the synchronization processing in order of shortness of delay time period.

The period T_{P} and the supposed maximum time period difference T_{MM} are determined in advance on the basis of experiment, simulation, experience, and the like, from the standpoint of correct and quick measurement of the various aspects of the synchronization correction processing.

On the other hand, when measuring aspects of the frequency characteristic correction processing and the audio volume balance correction processing, in this embodiment, it is arranged to utilize continuous pink noise sound as the audio contents for measurement.

Returning to FIG. 6, the correction control unit 295 described above performs control processing corresponding to the operation inputted by the user, received from the operation input unit 160 as the operation input data IPD. When the user inputs to the operation input unit 160 a designation of the type of acoustic signal that corresponds to the audio to be replay outputted from the speaker units 910_{L}, through 910_{SR}, this correction control unit 295 sends to the signal selection units 112 and 114 the signal selection designations SL1 and SL2 that are required in order for audio to be outputted from the speaker units 910_{L} through 910_{SR} on the basis of the designated type of acoustic signal.

For example, when the acoustic signal UAS is designated by the user, the correction control unit 295 sends to the signal selection unit 114, as the signal selection designation SL2, a command to the effect that the signal UAD is to be selected. It should be understood that, if the acoustic signal UAS has been designated, then issue of the signal selection designation SL1 is not performed.

Furthermore, when the acoustic signal NAS is designated by the user, then the correction control unit 295 sends to the signal selection unit 112, as the signal selection designation SL1, a command to the effect that the signal ND1 is to be selected, and also sends to the signal selection unit 114, as the signal selection designation SL2, a command to the effect that the signal APD is to be selected. Yet further, when the acoustic signal NAD is designated by the user, then the correction control unit 295 sends to the signal selection unit 112, as the signal selection designation SL1, a command to the effect that the signal ND2 is to be selected, and also sends to the signal selection unit 114, as the signal selection designation SL2, a command to the effect that the signal APD is to be selected.

Moreover, when the user has inputted to the operation input unit 160 a command for measurement of aspects of sound field correction processing by the sound source device 920₀, the correction control unit 295 sends a measurement start command to the correction measurement unit 291 as a measurement control signal AMC. It should be understood that in this embodiment it is arranged, after generation of the acoustic signal UAS has been performed by the sound source device 920₀ on the basis of the corresponding audio contents, for the user to input to the operation input unit 160 the type of correction processing that is to be the subject of measurement, for each individual type of correction processing that is to be a subject for measurement. And, each time the measurement related to some individual type of correction processing ends, it is arranged for a correction measurement result AMR that specifies the individual type of correction processing for which the measurement has ended to be reported to the correction control unit 295.

Furthermore, upon receipt from the correction measurement unit 291 of a correction measurement result AMR as a result of individual correction processing measurement, on the basis of this correction measurement result AMR, the correction control unit 295 issues that frequency characteristic correction command FCC, or that delay control command DLC, or that audio volume correction command VLC, that is necessary in order for the sound field correction unit 113 to execute correction processing upon the signal SND in relation to an aspect thereof that is similar to the aspect of this measured individual correction processing. The frequency characteristic correction command FCC, the delay control command DLC, or the audio volume correction command VLC that is generated in this manner is sent to the sound field correction unit 113. And the type of this individual correction processing, and the fact that measurement thereof has ended, are displayed on the display device of the display unit 150.

### <Operation>

Next, the operation of this acoustic signal processing device 100 having the structure described above will be explained, with attention being principally directed to the processing that is performed by the processing control unit 119.

### <Settings for Measurement of Aspects of the Sound Field Correction by the Sound Source Device 920₀, and for the Sound Field Correction Unit 113>

First, the processing for setting measurement of aspects of the sound field correction processing by the sound source device 920₀, and for setting the sound field correction unit 113, will be explained.

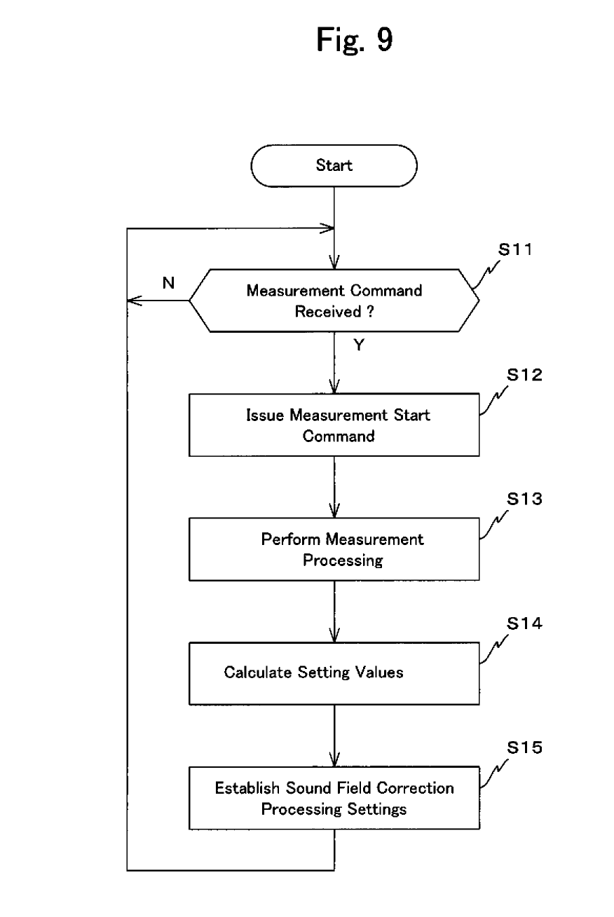

In this processing, as shown in FIG. 9, in a step S11, the correction control unit 295 of the processing control unit 119 makes a decision as to whether or not a measurement command has been received from the operation input unit 160. If the result of this decision is negative (N in the step S11), then the processing of the step S11 is repeated.

In this state, the user employs the operation input unit 160 and causes the sound source device 920₀ to start generation of the acoustic signal UAS on the basis of audio contents corresponding to the individual correction processing that is to be the subject of measurement. Next, when the user inputs to the operation unit 160 a measurement command in which the individual correction processing that is to be the first subject of measurement is designated, this is taken as operation input data IPD, and a report to this effect is sent to the correction control unit 295.

Upon receipt of this report, the result of the decision in the step S11 becomes affirmative (Y in the step S11), and the flow of control proceeds to a step S12. In this step S12, the correction control unit 295 issues to the correction measurement unit 291, as a measurement control signal AMC, a measurement start command in which is designated the individual measurement processing that was designated by the user in the measurement command.

Subsequently, in a step S13, the correction measurement unit 291 measures that aspect of individual correction processing that was designated by the measurement start command. During this measurement, the correction measurement unit 291 gathers from the reception processing unit 111 the signal levels of the individual signals UAD_{L} through UAD_{SR} in the signal UAD over a predetermined time period. And the correction measurement unit 291 analyzes the results that it has gathered, and measures that aspect of the individual correction processing.

Here, if the individual correction processing designated by the measurement start command is frequency characteristic correction processing, then first the correction measurement unit 291 calculates the frequency distribution of the signal level of each of the individual signals UAD_{L} through UAD_{SR} on the basis of the results that have been gathered. And the correction measurement unit 291 analyzes the results of these frequency distribution calculations, and thereby measures the frequency characteristic correction processing aspect. The result of this measurement is reported to the correction control unit 295 as a correction measurement result AMR.

Furthermore, if the individual correction processing that was designated by the measurement start command is synchronization correction processing, then first the correction measurement unit 291 starts gathering data, and specifies the timing at which each of the various individual signals UAD_{L} through UAD_{SR} goes into the signal present state, in which it is at or above an initially predetermined level. After time periods T_{P}/2 from these specified timings have elapsed, the correction measurement unit 291 specifies the timing at which each of the individual signals UAD_{L} through UAD_{SR} goes into the signal present state. And the correction measurement unit 291 measures the synchronization correction processing aspect on the basis of these results. The result of this measurement is reported to the correction control unit 295 as a correction measurement result AMR.

Moreover, if the individual correction processing that was designated by the measurement start command is audio volume balance correction processing, then first, on the basis of the gathered results; the correction measurement unit 291 calculates the average signal level of each of the individual signals UAD_{L} through UAD_{SR}. And the correction measurement unit 291 analyzes the mutual signal level differences between the individual signals UAD_{L} through UAD_{SR}, and thereby performs measurement for the aspect of audio volume balance correction processing. The result of this measurement is reported to the correction control unit 295 as a correction measurement result AMR.

Next in a step S14, upon receipt of the correction measurement results AMR and on the basis of these correction measurement results AMR, the correction control unit 295 calculates setting values for individual correction processing by the sound field correction unit 113 according to aspects that are similar to these correction measurement results AMR. For example, if a correction measurement result AMR has been received that is related to the frequency characteristic correction processing aspect, then the correction control unit 295 calculates setting values that are required for setting the frequency characteristic correction unit 231 of the sound field correction unit 113. Furthermore, if a correction measurement result AMR has been received that is related to the synchronization correction processing aspect, then the correction control unit 295 calculates setting values that are required for setting the delay correction unit 232 of the sound field correction unit 113. Moreover, if a correction measurement result AMR has been received that is related to the audio volume balance correction processing aspect, then the correction control unit 295 calculates setting values that are required for setting the audio volume correction unit 233 of the sound field correction unit 113.

Next in a step S15 the correction control unit 295 sends the results of calculation of these set values to the corresponding one of the frequency characteristic correction unit 231, the delay correction unit 232, and the audio volume correction unit 233. Here, a frequency characteristic correction command FCC in which the setting values are designated is sent to the frequency characteristic correction unit 231. Furthermore, a delay control command DLC in which the setting values are designated is sent to the delay correction unit 232. Moreover, an audio volume correction command VLC in which the setting values are designated is sent to the audio volume correction unit 233. As a result, individual correction processing that is similar to the individual correction processing that has been measured comes to be executed upon the signal SND by the sound field correction unit 113.

When the measurements for the aspects of individual measurement processing and the settings to the sound field correction unit 113 for the aspects of individual correction processing on the basis of the measurement results have been completed in this manner, then the correction control unit 295 displays a message to this effect upon the display device of the display unit 150

After this, the flow of control returns to the step S11. The processing of the steps S11 through S15 described above is then repeated.

### <Selection of Audio for Replay>

Next, the processing for selecting the audio to be replay outputted from the speaker units 910_{L} through 910_{SR} will be explained.

When the user inputs to the operation input unit 160 a designation of the type of acoustic signal that corresponds to the audio that is to be replayed and outputted from the speaker units 910_{L} through 910_{SR}, then a message to this effect is reported to the correction control unit 295 as operation input data IPD. Upon receipt of this report, the correction control unit 295 sends to the signal selection units 112 and 114 the signal selection designations SL1 and SL2 that are required in order for audio on the basis of that designated acoustic signal to be outputted from the speaker units 910_{L} through 910_{SR}.

Here, if the acoustic signal UAS is designated, then the correction control unit 295 sends to the signal selection unit 114, as the signal selection designation SL2, a command to the effect that the signal UAD should be selected. It should be understood that, if the acoustic signal UAS has been designated, then issue of the signal selection designation SL1 is not performed. As a result, output acoustic signals AOS_{L} through AOS_{SR} that are similar to the acoustic signal UAS are supplied to the speaker units 910_{L} through 910_{SR}.

And here, if the acoustic signal NAS is designated, then the correction control unit 295 sends to the signal selection unit 112, as the signal selection designation SL1, a command to the effect that the signal ND1 should be selected, and also sends to the signal selection unit 114, as the signal selection designation SL2, a command to the effect that the signal APD should be selected. As a result, after having performed measurement of all of the aspects of the various sound field processes for individual sound field processing according to the working of the above described sound source device 920₀, and after settings for all of the individual sound field correction processes have been set for the sound field correction unit 113 on the basis of the measurement results, output acoustic signals AOS_{L} through AOS_{SR} that have been generated by executing sound field correction processing upon the acoustic signal NAS in a manner similar to that performed during sound field correction processing by the sound source device 920₀ are supplied to the speaker units 910_{L} through 910_{SR}.

Moreover, if the acoustic signal NAD is designated, then the correction control unit 295 sends to the signal selection unit 112, as the signal selection designation SL1, a command to the effect that the signal ND2 should be selected, and also sends to the signal selection unit 114, as the signal selection designation SL2, a command to the effect that the signal APD should be selected. As a result, after having performed measurement of all of the aspects of the various sound field processes according to the working of the above described sound source device 920₀ for individual sound field processing, and after settings for all of the individual sound field correction processes have been set to the sound field correction unit 113 on the basis of the measurement results, output acoustic signals AOS_{L} through AOS_{SR} that have been generated by executing sound field correction processing upon the acoustic signal NAD in a manner similar to that performed during sound field correction processing by the sound source device 920₀ are supplied to the speaker units 910_{L} through 910_{SR}.

As has been explained above, in this embodiment, the correction measurement unit 291 of the processing control unit 119 measures aspects of the sound field correction processing executed upon the acoustic signal UAS received from the sound source device 920₀, which is a specified external device. If one of the acoustic signals other than the acoustic signal UAS, i.e. the acoustic signal NAS or the acoustic signal NAD, has been selected as the acoustic signal to be supplied to the speaker units 910_{L} through 910_{SR}, then an acoustic signal is generated by executing sound field correction processing of the aspect measured as described above upon that selected acoustic signal. Accordingly it is possible to supply output acoustic signals AOS_{L} through AOS_{SR} to the speaker units 910_{L} through 910_{SR} in a state in which uniform sound field correction processing has been executed, whichever of the acoustic signals UAS, NAS, and NAD may be selected.

Moreover, in this embodiment, when measuring the synchronization correction processing aspect included in the sound field correction processing by the sound source device 920₀, sounds in pulse form that are generated simultaneously for the L through SR channels at the period T_{P} are used as the audio contents for measurement. Here, a time period is taken for the period T_{P} that is more than twice as long as the supposed maximum time period difference T_{MM} that is supposed to be the maximum delay time period difference T_{DM}, which is the maximum value of the differences between the delay time periods imparted to the individual acoustic signals UAS_{L} through UAS_{SR} by the synchronization correction processing by the sound source device 920₀. Due to this, if the maximum delay time period difference T_{DM} is less than or equal to the supposed maximum time period difference T_{MM}, then, even if the timing of generation of the acoustic signal UAD for the measurement in the synchronization correction processing and the timing at which the signal UAD is collected by the correction measurement unit 291 are initially deviated from one another, which is undesirable, nevertheless it is possible for the correction measurement unit 291 correctly to measure the aspect of synchronization correction processing by the sound source device 920₀ by analyzing change of the signal UAD, after the no-signal interval of the signal UAD has continued for the time period T_{P}/2 or longer.

### Variant Embodiments

The present invention is not limited to the embodiment described above; alterations of various types are possible.

For example, the types of individual sound field correction in the embodiment described above are given by way of example; it would also be possible to reduce the types of individual sound field correction, or alternatively to increase them with other types of individual sound field correction.

Furthermore while, in the embodiment described above, pink noise sound was used during measurement for the frequency characteristic correction processing aspect and during measurement for the audio volume balance correction processing aspect, it would also be acceptable to arrange to use white noise sound.

Yet further, during measurement for the synchronization correction processing aspect, it would be possible to employ half sine waves, impulse waves, triangular waves, sawtooth waves, spot sine waves or the like.

Moreover while, in the embodiment described above, it was arranged for the user to designate the type of individual sound field correction that was to be the subject of measurement for each of the aspects of individual sound field correction processing. However, it would also be acceptable to arrange to perform the measurements for the three types of aspects of individual sound field processing in a predetermined sequence automatically, by establishing synchronization between the generation of the acoustic signal UAS for measurement by the sound source device 920₀, and measurement processing by the acoustic signal processing device 100.

Even further, the format of the acoustic signals in the embodiment described above is only given by way of example; it would also be possible to apply the present invention even if the acoustic signals are received in a different format. Furthermore, the number of acoustic signals for which sound field correction is performed may be any desired number.

Yet further while, in the embodiment described above, it was arranged to employ the four channel surround sound format and to provide four speaker units. However, it would also be possible to apply the present invention to an acoustic signal processing device which separates or mixes together acoustic signals resulting from reading out audio contents, as appropriate, and which causes the resulting audio to be outputted from two speakers or from three speakers, or from five or more speakers.

It should be understood that it would also be possible to arrange to implement the control unit of any of the embodiments described above as a computer system that comprises a central processing device (CPU: Central Processing Unit) or a DSP (Digital Signal Processor), and to arrange to implement the functions of the above control unit by execution of one or more programs. It would be possible to arrange for these programs to be acquired in the format of being recorded upon a transportable recording medium such as a CD-ROM, a DVD, or the like; or it would also be acceptable to arrange for them to be acquired in the format of being transmitted via a network such as the internet or the like.

1.-10. (canceled)

11. An acoustic signal processing device that creates acoustic signals that are supplied to a plurality of speakers, characterized by comprising:
a reception part configured to receive an acoustic signal from each of a plurality of external devices;
a measurement part configured to measure an aspect of sound field correction processing executed upon an acoustic signal received from a specified one of said plurality of external devices; and
a generation part configured to generate acoustic signals by executing sound field correction processing upon said selected acoustic signal for the aspect measured by said measurement part, when an acoustic signal received from an external device other than said specified external device has been selected, as acoustic signals to be supplied to said plurality of speakers.

12. An acoustic signal processing device according to claim 11, characterized in that said measurement part measures said aspect of said sound field correction processing by analyzing an acoustic signal generated by said specified external device from audio contents for measurement.

13. An acoustic signal processing device according to claim 11, characterized in that:
said specified external device is mounted to a mobile unit; and
the acoustic signal received from said specified external device is an acoustic signal for which sound field correction processing corresponding to a sound field space internal to said mobile unit has been executed upon an original acoustic signal.

14. An acoustic signal processing device according to claim 11, characterized in that said sound field correction processing includes synchronization correction processing to correct the timing of audio output from each of said plurality of speakers.

15. An acoustic signal processing device according to claim 14, characterized in that:
during measurement with said measurement part of an aspect of synchronization correction processing included in said sound field correction processing, as individual source acoustic signals corresponding to each of said plurality of speakers in the original acoustic signal that corresponds to the acoustic signal from said specified external device, signals in pulse form are used that are generated simultaneously at a period that is more than twice as long as the maximum mutual delay time period difference imparted by said synchronization processing to each of said individual source acoustic signals; and
said measurement part measures an aspect of said synchronization correction processing on the basis of the acoustic signal from said specific external device, after half of said period has elapsed from the time point at which a signal in pulse form has been initially detected in any one of said individual acoustic signals of the acoustic signal from said specified external device.

16. An acoustic signal processing device according to claim 11, characterized in that said sound field correction processing includes at least one of audio volume balance correction processing in which the balance between the audio volumes outputted from each of said plurality of speakers is corrected, and frequency characteristic correction processing in which the frequency characteristics of the acoustic signals supplied to each of said plurality of speakers is corrected.

17. An acoustic signal processing device according to claim 11, characterized in that the acoustic signals received from those of said plurality of external devices other than said specified external device are non-corrected acoustic signals upon which sound field correction processing has not been executed.

18. An acoustic signal processing method that creates acoustic signals that are supplied to a plurality of speakers, characterized by including:
a measurement process of measuring an aspect of sound field correction processing executed upon an acoustic signal received from a specified one of a plurality of external devices; and
a generation process of, when an acoustic signal received from an external device other than said specified external device has been selected, as acoustic signals to be supplied to said plurality of speakers, generating acoustic signals by executing sound field correction processing upon said selected acoustic signal for the aspect measured by said measurement process.

19. An acoustic signal processing program, characterized in that it causes a calculation part to execute the acoustic signal processing method according to claim 18.

20. A recording medium, characterized in that an acoustic signal processing program according to claim 19 is recorded thereupon in a manner that is readable by a calculation part.

21. An acoustic signal processing device according to claim 12, characterized in that:
said specified external device is mounted to a mobile unit; and
the acoustic signal received from said specified external device is an acoustic signal for which sound field correction processing corresponding to a sound field space internal to said mobile unit has been executed upon an original acoustic signal.

22. An acoustic signal processing device according to claim 12, characterized in that said sound field correction processing includes synchronization correction processing to correct the timing of audio output from each of said plurality of speakers.

23. An acoustic signal processing device according to claim 13, characterized in that said sound field correction processing includes synchronization correction processing to correct the timing of audio output from each of said plurality of speakers.

24. An acoustic signal processing device according to claim 12, characterized in that said sound field correction processing includes at least one of audio volume balance correction processing in which the balance between the audio volumes outputted from each of said plurality of speakers is corrected, and frequency characteristic correction processing in which the frequency characteristics of the acoustic signals supplied to each of said plurality of speakers is corrected.

25. An acoustic signal processing device according to claim 13, characterized in that said sound field correction processing includes at least one of audio volume balance correction processing in which the balance between the audio volumes outputted from each of said plurality of speakers is corrected, and frequency characteristic correction processing in which the frequency characteristics of the acoustic signals supplied to each of said plurality of speakers is corrected.

26. An acoustic signal processing device according to claim 14, characterized in that said sound field correction processing includes at least one of audio volume balance correction processing in which the balance between the audio volumes outputted from each of said plurality of speakers is corrected, and frequency characteristic correction processing in which the frequency characteristics of the acoustic signals supplied to each of said plurality of speakers is corrected.

27. An acoustic signal processing device according to claim 15, characterized in that said sound field correction processing includes at least one of audio volume balance correction processing in which the balance between the audio volumes outputted from each of said plurality of speakers is corrected, and frequency characteristic correction processing in which the frequency characteristics of the acoustic signals supplied to each of said plurality of speakers is corrected.

28. An acoustic signal processing device according to claim 12, characterized in that the acoustic signals received from those of said plurality of external devices other than said specified external device are non-corrected acoustic signals upon which sound field correction processing has not been executed.

29. An acoustic signal processing device according to claim 13, characterized in that the acoustic signals received from those of said plurality of external devices other than said specified external device are non-corrected acoustic signals upon which sound field correction processing has not been executed.

30. An acoustic signal processing device according to claim 14, characterized in that the acoustic signals received from those of said plurality of external devices other than said specified external device are non-corrected acoustic signals upon which sound field correction processing has not been executed.
